(19) United States
(12) Patent Application Publication
(10) Pub. No.: US 2025/0233471 A1
(43) Pub. Date: Jul. 17, 2025

(54) STATOR OF ROTATING ELECTRICAL MACHINE

(71) Applicant: TOYOTA JIDOSHA KABUSHIKI KAISHA, Toyota-shi (JP)

(72) Inventor: Ryo ONO, Toyota-shi (JP)

(73) Assignee: TOYOTA JIDOSHA KABUSHIKI KAISHA, Toyota-shi (JP)

(21) Appl. No.: 19/007,777

(22) Filed: Jan. 2, 2025

(30) Foreign Application Priority Data
Jan. 16, 2024 (JP) 2024-004669

(51) Int. Cl. H02K 3/34

(52) U.S. Cl. CPC H02K 3/345

(57) ABSTRACT

The stator of the rotating electrical machine includes a stator core and a stator coil wound around the stator core. The stator coil is composed of a plurality of segment coils constituted by a first segment coil, a second segment coil, and a coupling member connecting the first segment coil and the second segment coil, and a slot paper having an insulating property is wound around the stator coil, and the slot paper has a high thermal conductivity portion at a position corresponding to the coupling member.

### CROSS-REFERENCE TO RELATED APPLICATION

This application claims priority to Japanese Patent Application No. 2024-004669 filed on Jan. 16, 2024, incorporated herein by reference in its entirety.

### BACKGROUND

### 1. Technical Field

The present disclosure relates to a stator of a rotating electrical machine.

### 2. Description of Related Art

Japanese Unexamined Patent Application Publication No. 2020-102980 (JP 2020-102980 A) discloses a rotating electrical machine that includes a stator having a segment coil in which a first segment coil and a second segment coil are coupled by a coupling member.

### SUMMARY

At a coupling portion where the first segment coil and the second segment coil are coupled by the coupling member in the segment coil, an amount of heat generation increases due to an electrical resistance increasing, and there is a risk that a temperature of the segment coil increases.

The present disclosure has been made in view of the problem, and an objective of the present disclosure is to provide a stator of a rotating electrical machine that can reduce a temperature increase of a segment coil.

In order to solve the problem and achieve the objective, a stator of a rotating electrical machine relating to the present disclosure includes
a stator core, and a stator coil wound around the stator core, in which
the stator coil is made of a plurality of segment coils,
the plurality of segment coils is configured of a first segment coil, a second segment coil, and a coupling member that couples the first segment coil and the second segment coil,
a slot paper that has an insulating property is wound around the stator coil, and
the slot paper has a high thermal conductivity portion at a position corresponding to the coupling member.

Accordingly, the stator of the rotating electrical machine relating to the present disclosure has heat generated in a coupling portion where the first segment coil and the second segment coil are coupled by the coupling member in the segment coil that easily moves to the stator core via the high thermal conductivity portion of the slot paper. As a result, a temperature increase of the segment coil can be reduced.

Moreover, in the stator of the rotating electrical machine, the slot paper may have the high thermal conductivity portion provided in a band shape in a radial direction of the stator core, and
the high thermal conductivity portion may have a higher thermal conductivity than a portion other than the high thermal conductivity portion in the slot paper.

Accordingly, the high thermal conductivity portion can be positioned in accordance with a position in an axial direction of the coupling member of the segment coil.

Since the stator of the rotating electrical machine relating to the present disclosure has heat generated in a coupling portion of the segment coil that easily moves to the stator core via the high thermal conductivity portion of the slot paper, the stator of the rotating electrical machine accomplishes an effect in which a temperature increase of the segment coil can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a cross-sectional view illustrating a schematic configuration of a stator according to an embodiment;

FIG. 2 is an enlarged cross-sectional view of the stator according to the embodiment;

FIG. 3 is a view showing a segment coil in which a first segment coil and a second segment coil are connected by a connecting pipe;

FIG. 4 is a view showing a positional relation between a high thermal conductivity portion of a slot paper and a coupling portion of a segment coil in a slot; and

FIG. 5 is a perspective view illustrating a positional relationship between a high thermal conductivity portion of the slot paper and a coupling portion of the segment coil.

### DETAILED DESCRIPTION OF EMBODIMENTS

Hereinafter, an embodiment of a stator of a rotating electrical machine according to the present disclosure will be described. This embodiment is not intended to limit the present disclosure.

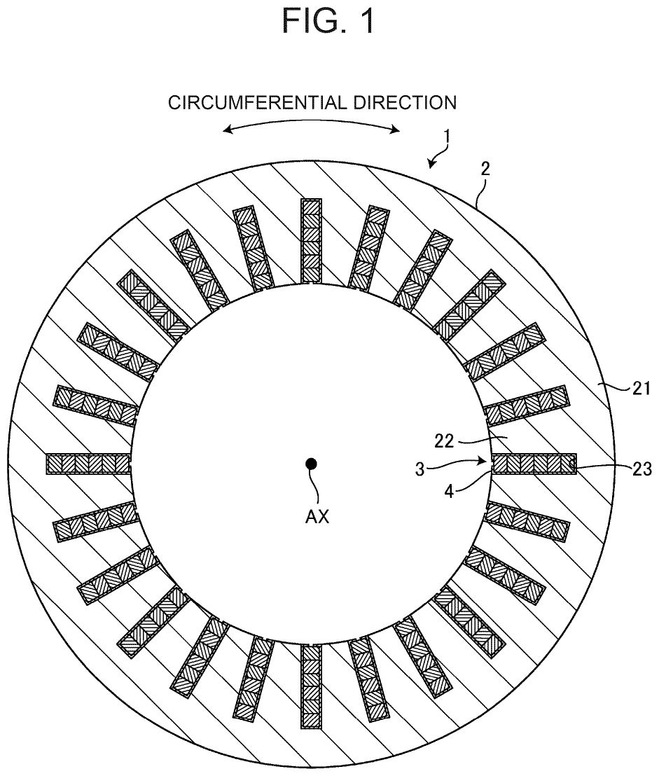

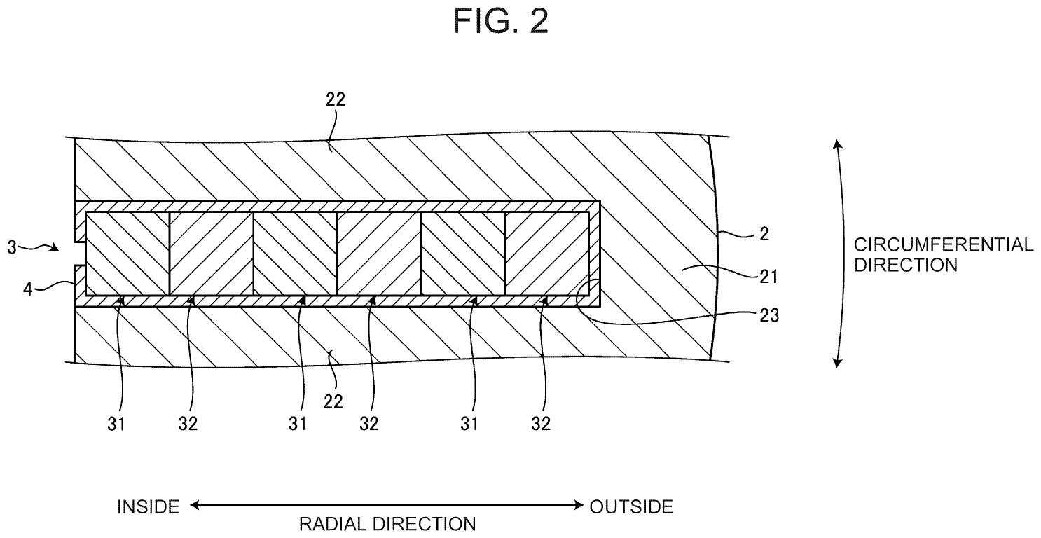

FIG. 1 is a cross-sectional view illustrating a schematic configuration of a stator 1 according to an embodiment. FIG. 2 is an enlarged cross-sectional view of the stator 1 according to the embodiment.

The stator 1 of the present embodiment is combined with a rotor to form a rotating electrical machine. The rotating electrical machine to which the stator 1 is applied may be one used as an electric motor or one used as a generator. Therefore, the stator 1 may be applied to, for example, a rotating electrical machine mounted on an electrified vehicle and functioning as an electric motor that generates driving power, and also functioning as a generator that generates electric power by regenerative torque or the like.

The stator 1 includes a stator core 2 and a stator coil 3 wound around the stator core 2. The stator core 2 is roughly divided into a substantially annular core back 21 and a plurality of teeth 22 protruding in a radial direction inward from an inner circumferential surface of the core back 21. A slot 23, which is a space in which the stator coil 3 is accommodated, is formed between the teeth 22 adjacent in the circumferential direction. The stator core 2 is manufactured, for example, by laminating a plurality of electromagnetic steel sheets in the thickness direction.

The stator coil 3 is wound around the teeth 22 of the stator core 2. The connection mode and the winding mode of the stator coil 3 may be appropriately selected according to the specifications of the rotating electrical machine. Therefore, the stator coil 3 may be configured such that the U-phase, V-phase, and W-phase coils are connected by star or delta. Further, the stator coil 3 may be wound by distributed winding, or may be wound by concentrated winding. In any case, in the present embodiment, the stator coil 3 includes a plurality of segment coils. In the stator 1 according to the embodiment, six segment coils are inserted into one slot 23.

The segment coil is obtained by cutting the stator coil 3 with a length that is easy to handle. In the present embodiment, the segment coil includes the first segment coil 31 and the second segment coil 32.

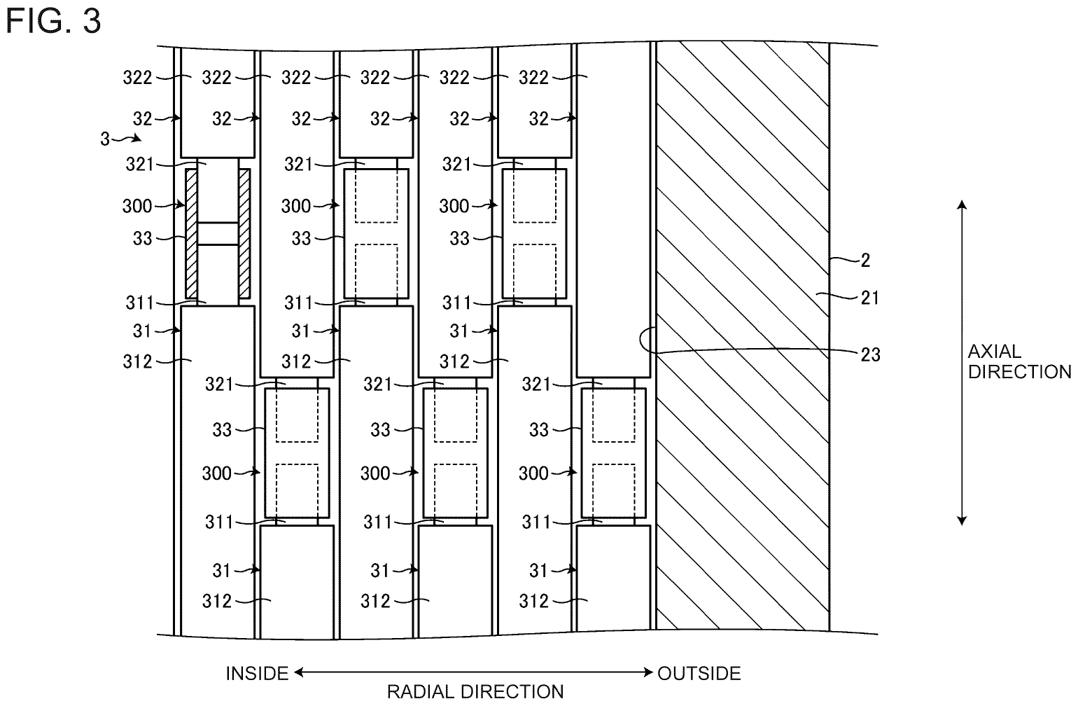

FIG. 3 is a view showing a segment coil in which the first segment coil 31 and the second segment coil 32 are connected by a connecting pipe 33.

The first segment coil 31 is formed by coating a conductive wire 311 made of a conductive material (for example, copper or the like) with a coil film 312 made of an insulating material. The conductive wire 311 is a corner line having a substantially rectangular cross-sectional shape. In addition, the first segment coil 31 is bent and formed into the same shape as when the stator is completed, that is, a final shape. Specifically, the first segment coil 31 has a substantially U-shape having a pair of vertical line portions accommodated in the slot 23 and a connecting portion connecting the pair of vertical line portions. The length of the vertical line portion is substantially the same as the axial direction dimension of the stator core 2. In the present embodiment, the “axial direction” is an axial AX direction of the stator core 2. When the vertical line portion of the first segment coil 31 is inserted into the slot 23, the end of the vertical line portion is positioned in the vicinity of the axial end portion of the slot 23. The connecting portion extends in the circumferential direction outside the stator core 2 in the axial direction and constitutes a part of the coil end. At both ends of the first segment coil 31, that is, at the end of the vertical line portion, the coil film 312 is peeled off, and a peeled portion in which the conductive wire 311 is exposed to the outside is formed.

The second segment coil 32 is formed by coating a conductive wire 321 made of a conductive material (for example, copper or the like) with a coil film 322. The conductive wire 321 is a corner line having a substantially rectangular cross-sectional shape. In addition, the second segment coil 32 is bent and formed into the same shape as when the stator is completed, that is, a final shape. Specifically, the second segment coil 32 has a substantially U-shape having a pair of vertical line portions accommodated in the slot 23 and a connecting portion connecting the pair of vertical line portions. The length of the vertical line portion is substantially the same as the axial direction dimension of the stator core 2. Therefore, when the vertical line portion is inserted into the slot 23, the end of the vertical line portion is positioned in the vicinity of the axial end portion of the slot 23. The connecting portion extends in the circumferential direction outside the stator core 2 in the axial direction and constitutes a part of the coil end. The coil film 322 is peeled off at both ends of the second segment coil 32, and a peeling portion in which the conductive wire 321 is exposed to the outside is formed.

In the present embodiment, the conductive wire 311 and the conductive wire 321 used for the first segment coil 31 and the second segment coil 32, respectively, have a substantially rectangular cross-sectional shape, but may be round wires having a circular cross-sectional shape.

The first segment coil 31 and the second segment coil 32 are connected to each other via a connecting pipe 33 whose end portions are hollow coupling members. The connecting pipe 33 has a cylindrical shape in which a through hole penetrating in the axial direction is formed. The connecting pipe 33 is made of a conductive material (for example, copper or the like), is electrically connected by being fitted to the first segment coil 31 and the second segment coil 32, and functions as a part of the current path of the stator coil 3, that is, a part of the stator coil 3. The connecting pipe 33 is arranged so that the entire connecting pipe 33 fits in the slot 23 of the stator core 2. At this time, as shown in FIG. 3, the positions of the connecting pipes 33 of the plurality of segment coils arranged in the radial direction in the slot 23 are shifted so as not to be adjacent to each other in the axial direction in order to suppress an electrical short circuit between the connecting pipes 33 adjacent to each other in the radial direction.

When the first segment coil 31 and the second segment coil 32 are connected to each other via the connecting pipe 33, first, outside the slot 23 of the stator core 2, for example, by press-fitting the conductive wire 311 of the first segment coil 31 to one end portion of the connecting pipe 33. Thereafter, in the slot 23 of the stator core 2, the conductive wire 321 of the second segment coil 32 is press-fitted to the other end portion of the connecting pipe 33. Note that, outside the slot 23 of the stator core 2, for example, the conductive wire 321 of the second segment coil 32 may be press-fitted into one end portion of the connecting pipe 33. Thereafter, in the slot 23 of the stator core 2, the conductive wire 311 of the first segment coil 31 to the other end portion of the connecting pipe 33 may be press-fitted.

In the stator 1 according to the embodiment, as shown in FIG. 1 and FIG. 2, a slot paper 4 having an insulating property is provided between the outer peripheral surface of the stator coil 3 inserted into the slot 23 provided in the stator core 2 and the inner peripheral surface of the slot 23. The slot paper 4 is wound around the stator coil 3, and is a member that enhances insulation between the stator core 2 and the stator coil 3. The slot paper 4 has a high thermal conductivity portion 41 and a normal portion 42. The high thermal conductivity portion 41 is a portion having higher thermal conductivity than the normal portion 42. As a method for treating the high thermal conductivity of the high thermal conductivity portion 41 in the slot paper 4, for example, a method of applying a heat dissipation material having high thermal conductivity such as metal powder to the slot paper 4 is exemplified.

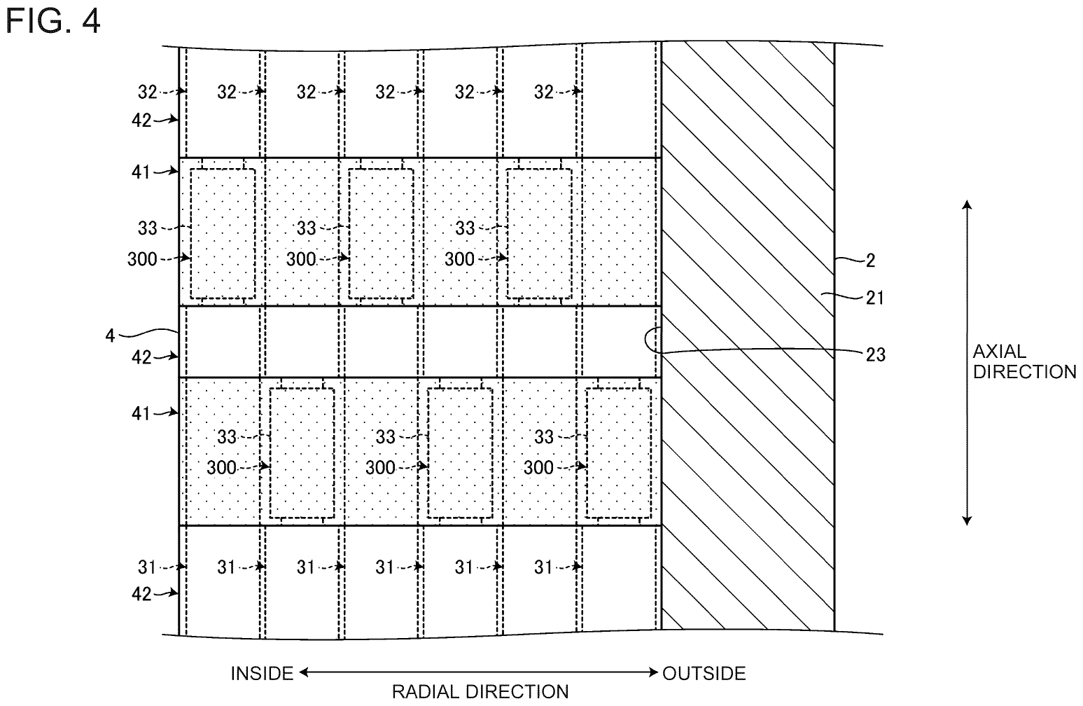

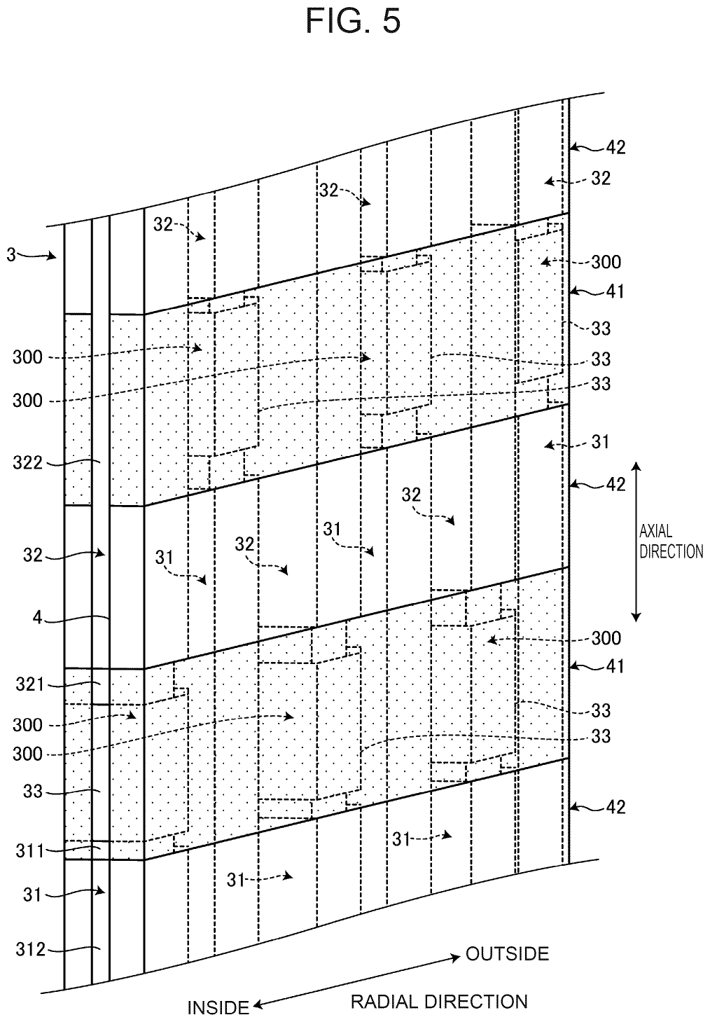

FIG. 4 is a view showing the positional relationship between the high thermal conductivity portion 41 of the slot paper 4 and the coupling portion 300 of the segment coil in the slot 23. FIG. 5 is a perspective view showing a positional relationship between the high thermal conductivity portion 41 of the slot paper 4 and the coupling portion 300 of the segment coil.

As shown in FIG. 4 and FIG. 5, in the stator 1 according to the embodiment, the high thermal conductivity portion 41 of the slot paper 4 is positioned so as to correspond to (contact with) the coupling portion 300 (connecting pipe 33) of the segment coil. The slot paper 4 is wound around the stator coil 3 (six segment coils). Note that, as shown in FIG. 5, the slot paper 4 is wound around the stator coil 3 (six segment coils) so that a gap is formed in the inner end portion in the radial direction, but the slot paper 4 may be wound around the entire circumference of the stator coil 3.

In the coupling portion 300 of the segment coil, the amount of heat generation is increased as compared with a portion other than the coupling portion 300 of the segment coil. The reason is that, in the segment coil, the conductive wire 311 of the first segment coil 31 and the conductive wire 321 of the second segment coil 32 come into contact with the connecting pipe 33, so that the electrical resistance at the contact portion thereof increases more than the conductive wires 311, 321 alone. Since the amount of heat generation when the current flows is proportional to the resistance value of the material, an increase in the amount of heat generation in the coupling portion 300 of the segment coil (temperature increase), and consequently, a temperature increase of the entire segment coil (stator coil 3) occurs.

In this way, the temperature of the coupling portion 300 of the segment coil and the entire segment coil (the stator coil 3) increases. As a result, the temperature exceeds, for example, the heat resistance limit of the insulating film (the coil films 312, 322) applied to the connecting pipe 33, the first segment coil 31, and the second segment coil 32. As a result, an electrical short-circuit may be caused. Further, in order to suppress this, it is necessary to strengthen a cooling mechanism of the segment coil, for example, a mechanism for cooling the segment coil by flowing cooling oil to the segment coil. As a result, an adverse effect such as an increase in cost and vehicle weight due to an improvement in the performance of the cooling mechanism occurs.

In order to reduce the temperature rise of the coupling portion 300 of the segment coil and the entire segment coil (the stator coil 3), the stator 1 according to the embodiment is configured as follows. That is, the high thermal conductivity portion 41 of the slot paper 4 is positioned so as to correspond to (contact with) the coupling portion 300 (connecting pipe 33) of the segment coil. As a result, the coupling portion 300 of the segment coil having a large amount of heat generation comes into contact with the high thermal conductivity portion 41 of the slot paper 4, thereby improving the thermal conductivity to the stator core 2. That is, the thermal conductivity from the coupling portion 300 (connecting pipe 33) of the segment coil to the stator core 2 via the high thermal conductivity portion 41 of the slot paper 4 is improved. Therefore, the heat generated in the coupling portion 300 of the segment coil easily moves from the high thermal conductivity portion 41 of the slot paper 4 to the stator core 2, and an increase in the amount of heat generation in the segment coil can be suppressed. Therefore, it is possible to reduce the temperature rise of the coupling portion 300 of the segment coil, and thus the temperature rise of the entire segment coil (the stator coil 3). That is, since heat can be dissipated to the outside of the segment coil, it is possible to reduce the temperature rise of the entire segment coil (stator coil 3) as a result.

The position of the coupling portion 300 (connecting pipe 33) in the axial direction in the segment coil may be any position as long as it is within the slot 23, that is, within a range in which the slot paper 4 can cover the segment coil. Further, in FIG. 4 and FIG. 5, the high thermal conductivity portion 41 of the slot paper 4 is divided into two portions in the axial direction, this is because the axial position of the coupling portion 300 (connecting pipe 33) in the segment coil is divided into two portions. That is, for example, consider a case where the position of the coupling portion 300 (connecting pipe 33) in the axial direction of the segment coil is three or more or only one. Even in this case, it is possible to adapt by setting the high thermal conductivity portion 41 of the slot paper 4 to three or more or only one portion so as to correspond to the coupling portion 300 of the segment coil.

Further, as shown in FIG. 4 and FIG. 5, the high thermal conductivity portion 41 of the slot paper 4 is provided in a band shape in the radial direction. In addition, not only the coupling portion 300 (the connecting pipe 33) of the segment coil but also a portion other than the coupling portion 300 (the connecting pipe 33) (the coil film 312,322) is located at the position of the high thermal conductivity portion 41 having the same belt shape. On the other hand, the high thermal conductivity portion 41 of the slot paper 4 may be provided only at the position of the coupling portion 300 (connecting pipe 33) of the segment coil in the radial direction.

In addition, the length of the slot paper 4 in the axial direction of the high thermal conductivity portion 41 may be at least the same as the length of the coupling portion 300 (connecting pipe 33) of the segment coil in the axial direction. On the other hand, it is preferable that the length of the slot paper 4 in the axial direction of the high thermal conductivity portion 41 is longer than the length of the coupling portion 300 (connecting pipe 33) of the segment coil in the axial direction. This is because the heat generated in the coupling portion 300 (connecting pipe 33) of the segment coil moves a little in the axial direction.

Further, as a method of processing the high thermal conductivity of the high thermal conductivity portion 41 in the slot paper 4, for example, the configuration of the slot paper 4 may be changed. For example, the slot paper 4 is generally one in which a plurality of layers are folded and overlapped, but the slot paper 4 may be formed by reducing the number of layers overlapping the portion (the high thermal conductivity portion 41) of the segment coil in contact with the coupling portion 300 with respect to the other portion (the normal portion 42).

Further, as the high thermal conductivity of the high thermal conductivity portion 41 in the slot paper 4, for example, a material configuration of an insulating layer, an adhesive, or the like may be changed between the high thermal conductivity portion 41 and the normal portion 42.

What is claimed is:

1. A stator of rotating electrical machine, the stator comprising:
a stator core; and
a stator coil wound around the stator core, wherein
the stator coil is made of a plurality of segment coils,
the plurality of segment coils is configured of a first segment coil, a second segment coil, and a coupling member that couples the first segment coil and the second segment coil,
a slot paper that has an insulating property is wound around the stator coil, and
the slot paper has a high thermal conductivity portion at a position corresponding to the coupling member.

2. The stator according to claim 1, wherein:
the slot paper has the high thermal conductivity portion provided in a band shape in a radial direction of the stator core; and
the high thermal conductivity portion has a higher thermal conductivity than a portion other than the high thermal conductivity portion in the slot paper.
